(19) United States
(12) Patent Application Publication
(10) Pub. No.: US 2019/0146471 A1
(43) Pub. Date: May 16, 2019

(54) A METHOD FOR MONITORING THE OPERATIONAL STATE OF A SYSTEM

(71) Applicant: Interactive Coventry Limited, Coventry (GB)

(72) Inventors: Tomasz Maniak, Coventry (GB); Rahat Iqbal, Coventry (GB); Faiyaz Doctor, Coventry (GB)

(73) Assignee: Interactive Coventry Limited, Conventry (GB)

(21) Appl. No.: 16/098,609

(22) PCT Filed: Apr. 12, 2017
(86) PCT No.: PCT/GB2017/051019

§ 371 Date: Nov. 2, 2018

(30) Foreign Application Priority Data
May 4, 2016 (GB) 1607820.6

(51) Int. Cl. G05B 23/02; G06N 7/00; G06F 16/906

(52) U.S. Cl. CPC G05B 23/0254; G05B 2223/02; G06F 16/906; G06N 7/005

(57) ABSTRACT

In the present invention signals are obtained from a plurality of sensors S₁, S₂, Sn and fed into an encoder (12). The encoder (12) is operable in use to receive input signals from each of the sensors S₁, S₂, Sₙ and translate said signals into one or more vectors characterising the state of one or more of the operational parameters of the monitored system, hereinafter referred to as an encoded vector V_{E}. The signals from the sensors S₁, S₂, Sₙ may relate to one or more different operational parameters of a connected system. The encoded vector V_{E} is fed into a translation engine 13 which translates the encoded vector V_{E} into feature space to form a feature vector V_{F}. The feature vector V_{F} is subsequently fed into a residual vector generator (16) which compares the feature vector V_{F} with a predicted vector V_{P} generated by a prediction engine (14) and thereby output a residual vector V_{R} which characterises any differences between the feature vector V_{F} and the predicted vector V_{P}, In addition, the feature vector V_{F} is also fed directly into the prediction engine (14). In this way, the current operational state of each of the variable parameters of the monitored system can be input into the prediction engine (14) to update subsequent predictions made by the prediction engine (14). The formed residual vector V_{R} is then input into a computation unit (18) for analysis, such as to determine whether the differences identified between the predicted and feature vectors V_{P}, V_{F} indicate that there is a fault in the monitored system.

### TECHNICAL FIELD OF THE INVENTION

The present invention relates to methods and systems for monitoring the state of an operational system, and in particular for detecting and isolating faults in operational systems.

### BACKGROUND TO THE INVENTION

Known methods for monitoring the operational state of a system, such as a system operating within a manufacturing process, include fault detection based on limit checking. That is, thresholds are set outlining minimal and maximal values for a given characteristic of the system and measuring, using sensors, whether that characteristic falls within this threshold range. This method, whilst simple and reliable is slow to react to changes in a given characteristic over a period of time and is incapable of identifying complex failures which can only be identified by looking at correlations between features.

To overcome these deficiencies it is known to use Statistical Process Control (SPC). SPC is essentially a statistical process based on the idea that each of the variables of a given process can be identified to have a mean value and a standard deviation from that mean value. SPC methods are generally concerned with the input of one particular variable at any given time. However, real world data, such as that obtained from monitoring manufacturing processes can commonly be spatial-temporal in nature, that is, there exist a number of correlations between different inputs (spatial) and how those different inputs vary in time (temporal).

There is therefore a need to provide a method of obtaining and processing data from an operational system which provides information on both the spatial and temporal variations in one or more variable parameters of an operational system.

It is therefore an aim of an embodiment or embodiments of the present invention to overcome or at least partially mitigate the problems associated with the prior art.

### SUMMARY OF THE INVENTION

According to a first aspect of the present invention there is provided a method for monitoring the operational state of a system having one or more variable parameters comprising the steps of:
(a) forming an input vector containing one or more values for the or each variable parameter of the monitored system;
(b) encoding the input vector to form an encoded vector;
(c) translating the encoded vector into feature space to form a feature vector;
(d) generating a predicted vector containing a corresponding number of predicted values for the values of the formed feature vector, wherein the predicted values are generated from statistical modelling of one or more previously generated feature vectors;
(e) subtracting the feature vector from a predicted vector to form a residual vector; and
(f) using the residual vector to identify one or more discrepancies in spatial and/or temporal changes in the or each variable parameter of the monitored system.

The formed residual vector is used to identify spatial and/or temporal changes in the or each variable parameter of the monitored system. For example, the formed residual vector may be used to identify the spatial and/or temporal differences between expected/normal system behaviour and observed system behaviour. When used here and throughout the specification, the term spatial change is intended to cover how the value or values of a given parameter change with respect to the value or values, or changes in said value/s, of one or more further variables. When used here and throughout the specification, the term temporal change is intended to cover how the value or values of a given parameter change with time.

The predicted vector may be generated from statistical modelling of one or more previously generated feature vectors. In some embodiments each time a feature vector is generated, the feature vector may additionally be incorporated into a statistical model for generating a further predicted vector for use in analysis of a subsequently formed feature vector.

In some embodiments the method comprises using a Markov chain to statistically model the feature vectors in order to generate a predicted vector. The method may comprise using a first order Markov chain, or preferably uses an N order Markov chain, which may be a high order Markov chain, to statistically model the measured system variables. The Markov chain may be used to determine transition properties of the monitored system. The transition properties will preferably relate to temporal transitions (i.e. how the variable parameter/s change over time).

The Markov chain may additionally be used to model the probability of various temporal transitions occurring (i.e. being seen in a subsequent measured vector) on the basis of one of more previously generated feature vectors. In this way, the Markov chain may be used to generate the predicted vector based on the most recent feature vector with reference to the probabilities of spatial or temporal transitions occurring before obtaining the next feature vector. For example, in the event that the statistical model suggests that the probability of there being any variation in one or more of the parameters is low (which may be below a specified threshold value) the predicted vector may be equal to the last feature vector. Alternatively, in the event that the statistical model suggests that the probability of there being any variation in one or more of the parameters is high (which may be above a specified threshold value) the predicted vector may differ from the last feature vector in relation to the variables which are deemed to have a high probability of varying, for example. The spatial and temporal transition properties are preferably stored for future reference. The transition properties may be stored in a look-up table. The look-up table may be continually updated each time a feature vector is generated to continually update the prediction process.

In some embodiments the method comprises assigning each feature vector to an individual system state. The individual system states may be used in the Markov chain to determine transition properties of the monitored system.

Each system state may correspond to a specific vector value, i.e. vectors are only assigned to a specific state where they comprise identical vector components to other vectors assigned to that state. Alternatively, vectors deemed to correlate in some way but which are not necessarily identical may be clustered together into a single system state. This may be done to reduce the number of variables to be statistically modelled in the generation of the predicted vector, for example.

In some embodiments the method may comprise clustering feature vectors which are separated by a pre-determined distance in feature space. The distance between two or more feature vectors may be calculated from the Euclidian distance between them. The clustering of two or more feature vectors may be expressed by a clustered vector in the same feature space. The cluster vector may be taken to be the midpoint between the two or more feature vectors. This clustering may be performed once for all feature vectors which are within a given distance from each other.

In further embodiments the method may comprise repeating the clustering process discussed above one or more times. For each subsequent run of the clustering process the threshold distance below which two vectors are deemed to correlate may be increased. For the second and subsequent runs of the clustering process, the method may comprise clustering two or more feature vectors together, one or more feature vectors with one or more generated cluster vectors, or two or more cluster vectors, for example. The clustering process may be repeated any number of times up until a single cluster vector is generated representing an overview of the system state. In this way, the method may comprise forming a hierarchical model of system states with each run of the clustering process corresponding to a tier of the hierarchy. This may be done to represent the overall operational state of the system as a function of each of the possible sub-states which may result in the same observed operation of the system.

The method comprises measuring at least one value for the or each variable parameter. The or each value measured may be acquired by monitoring equipment which may comprise one or more sensors, for example. The method may comprise measuring a value or values from two or more different types of sensor. In some embodiments the different types of sensor may be used to monitor different variable parameters. In some embodiments the at least two of the two or more different sensor types may output values of different data types. For example, the method may comprise measuring binary values for a given variable parameter (e.g. where the variable parameter can be in one of two states), or categorical values for a given variable parameter (e.g. where the variable parameter can be in one of two or more distinct states), or continuous values for a given variable parameter (e.g. where the variable parameter can take any value within a given range).

In some embodiments the method may comprise encoding the input vector by generating each vector component of the encoded vector as a binary number having a number of digits equal to a number of classes into which measured values of one or more variable parameters of the system may be classified, or which it is measured in the input vector. In such embodiments, each digit of the binary number may correspond to a specific class.

In some embodiments the digits of the generated binary number may be repeated one or more times to form a repeated binary number. The repeated binary number may be generated for stability during subsequent processing of the subsequently formed feature vector. In some embodiments the digits of the generated binary number may be repeated by repeating the whole of the generated binary number to form the repeated binary number. For example, in such embodiments a generated binary number may read [0010] and a corresponding repeated binary number would read [00100010], where the generated binary number is repeated once. Alternatively, the digits of the binary number may be repeated by repeating each of the digits of the generated binary number in turn. For example, in such embodiments a generated binary number may read [0010] and a corresponding repeated binary number would read [00001100], where the generated binary number is repeated once.

In some embodiments the method may comprise measuring at least one value of a variable parameter which may be in one of two classes, i.e. in one of two separate states. In such embodiments, the at least one value may be obtained using a binary sensor, wherein a value of “0” is assigned to one of the states and a value of “1” is assigned to the other of the two states. Variable parameters measurable using binary sensors may include a sensor to determine the switching state of a switch, i.e. on or off/open or closed, for example. The binary sensors may include one or more of any of a resistance touch switch, a capacitance switch, a piezo touch switch, proximity sensors, security systems for doors and windows including motion sensors, temperature controls such as thermostats, and a pressure switch control. In some embodiments the switching state of a switch may include power failure states, the position of cylinders, position of limit switches, push button position of a switch, the correct location of case clips, or screw detection, for example. In order to translate the measured values of the input vector from the binary sensor to real-number variables for inclusion in the encoded vector, the method may comprise encoding the date by simply assigning the binary value, i.e. 0 or 1, taken from the binary sensor to a corresponding component within the encoded vector.

In some embodiments the method may comprise measuring at least one value of a variable parameter which may fall into one of two or more classes, i.e. where the measured variable parameter may have one of two or more categorical values. In such embodiments, the method may comprise encoding the data from the input vector by assigning one or more components of the encoded vector to each category in which the variable parameter may be measured. Variable parameters having two or more categorical values may include colours, or operational settings having two or more discrete values, for example. In some embodiments the measured variable parameters may relate to component types. For example, the method may comprise monitoring the manufacturing of car instrument clusters which requires the assembly of a number of components which may include, for example, face dial variant type, pointer type, software level, eeprom level, or case type The method may further comprise measuring categorical values of any specific component for example, pointer colour or LED colour. The one or more components of the encoded vector may initially be set to have a real-number variable of 0, which may be increased to 1 in the event that a measured value of the variable parameter within the input vector falls within a corresponding category. The one or more components the encoded vector will preferably be sequential positions within the vector.

In some embodiments the method may comprise measuring at least one value of a variable parameter wherein the values which the variable parameter can take are continuous. In such embodiments, the method may comprise encoding the data from the input vector by assigning one or more components of the encoded vector to one or more classes in the form of intervals within which the value of the measured variable parameter may fall. Variable parameters which are continuous may include temperature, time, or weight, for example. In some embodiments the method may be used to monitor the operational state of the manufacturing of car instrument clusters which may include a number of components having continuous valued parameters. For example, various continuous parameters which may be measured include screw torque and angle measurements, gauge position, angle measurements, voltage values registered by a microprocessor, pointer positions, number of pixels on LCD, position of actuators and LCD brightness values. In other monitored systems, the method may comprise measuring continuous valued parameters which could temperature, pressure, flow rate, fluid velocity, fluid level, displacement, acceleration, force, density, luminosity, angle, electric current, electric potential, magnetic field strength, for example. The one or more components of the encoded vector may initially be set to have a real-number variable of 0, which may be increased to 1 in the event that a measured value of the variable parameter falls within a corresponding interval in the input vector. The one or more components of the encoded vector will preferably be sequential positions within the vector.

In some embodiments the method may comprise forming a normal distribution using two or more measured values of the variable parameter. In such embodiments, the normal distribution may be used to calculate the mean value (μ) of the variable parameter and also the standard deviation (σ) from this mean value. The method may comprise assigning the one or more components of the encoded vector to classes defined by intervals between two distinct multiples of standard deviation from the mean of the normal distribution of data points. For example, the interval width may be defined as 0.25 σ. In such embodiments one or more first components of the encoded vector may be assigned to values falling between 0 σ and 0.25 σ, one or more second components may be assigned to values falling between 0.25 σ and 0.5σ, one or more third components may be assigned to values falling between 0.5 σ and 0.75 σ, and so on up to one or more “nth” components in the encoded vector. The first, second, third and nth position(s) within the encoded vector may in some embodiments be sequential. In the event that a measured value of a given variable parameter falls within a given interval, the one or more vector components assigned to that interval may have their value set at 1, whereas each of the other components relating to the further intervals will have their value set at zero. In this way, the method comprises a means to encode continuous data from an input vector in a binary vector.

The method may comprise assigning one or more components of the encoded vector to a single value of a given variable parameter. In this way, the value of a given variable parameter may be represented by a single component of the encoded vector, or in a series of sequential vector components. For example, in embodiments wherein a variable parameter is binary in nature, i.e. capable of being in one of two states, the method may comprise assigning one or more components of the encoded vector to the single binary measurement. In effect, a portion of the formed encoded vector may read as follows: [1, 1, 1, 1] (where the value of the measured variable parameter is assigned a binary value of 1). In this example, the single value of the variable parameter is represented in the encoded vector at four consecutive vector components.

In embodiments wherein the variable parameter may have a value within one of two or more classes, i.e. where the variable parameter comprises categorical data, a first encoded vector may be generated as follows: [0, 0, 0, 1, 0], wherein the measured value of the variable parameter is determined to be within the fourth of five distinct categories. For the same measured parameter value, the formed encoded vector may be generated as follows: [0, 0, 0, 1, 0, 0, 0, 0, 1, 0], where the measured parameter value is represented in this encoded vector by repeating the five vector values of the first measured vector after the fifth vector component to double the number of vector components to ten. In this variant, the first and sixth vector components correspond to the first categorical value, the second and seventh vector components correspond to the second categorical value, the third and eighth components correspond to the third categorical value, the fourth and ninth components correspond to the fourth categorical value, and the fifth and tenth components correspond to the fifth categorical value of the variable parameter. Alternatively, for the same measured parameter value, the formed encoded vector may be generated as follows: [0, 0, 0, 0, 0, 0, 1, 1, 0, 0], where the measured parameter value is represented in this encoded vector by repeating each of the five vector values of the first measured vector in turn. In this variant, the first and second vector components correspond to the first categorical value, the third and fourth vector components correspond to the second categorical value, the fifth and sixth components correspond to the third categorical value, the seventh and eighth components correspond to the fourth categorical value, and the ninth and tenth components correspond to the fifth categorical value of the variable parameter. The method may comprise repeating the vector values as described above any number of times, such as twice (as described), or three, four, five or more times, as desired. This repetition of the assigned real-number variables of the measured value(s) of the parameters may be performed for stability purposes when processing the formed encoded vector in accordance with further steps of the method of the present invention.

The residual vector is generated by subtracting the feature vector from the predicted vector. This may comprise subtracting the or each real-number variable within the feature vector from a corresponding value in the predicted vector. The corresponding value in the predicted vector may be the equivalent vector component of the feature vector. For example, where a feature vector comprises two vector components, the first and second vector components of the feature vector may be subtracted from the first and second components of the predicted vector, respectively. In this way, the values contained within the residual vector illustrate any and all differences between corresponding vector components within the feature vector and the predicted vector. Where these are the same in both the feature vector and the predicted vector, the corresponding vector component in the residual vector will be zero indicating that the variable parameter to which that particular vector component relates is at an expected value (i.e. it has changed by a predicted amount or has remained constant).

In some embodiments the method may be used to monitor the operational state of a system to detect a fault within the system. For example, in some embodiments the method may comprise forming a residual vector which illustrates any discrepancies in expected spatial and temporal changes in the measured value or values of the or each variable parameter, wherein any identified discrepancies are taken to be an indication of a fault within the monitored system.

For example, in some embodiments a fault may be identified when at least one of component of the feature vector differs from a corresponding vector component of the predicted vector such that one or more of the components of the residual vector are not equal to zero. In some embodiments a fault may be identified only when two or more components of the feature vector differs from a corresponding vector component of the predicted vector such that two or more of the components of the residual vector are not equal to zero. In some embodiments a fault may be identified only when the magnitude of the residual vector exceeds a predetermined threshold value.

In some embodiments, a fault occurrence may be identified by using a threshold based on a distance metric between the predicted and feature vectors. For example, in some embodiments the method may comprise finding a Gaussian distribution of a given distance metric for normal behaviour of the process, i.e. taken from the predicted vectors, and set the threshold at a given number of standard deviations from the normal of the Gaussian distribution. The threshold may, in some embodiments, be set at 1, 2, 3, 4, or more standard deviations from the normal. In other embodiments the method may comprise training a simple linear classifier to learn the threshold.

In some embodiments the method may be used to monitor the operational state of a system forming at least part of a manufacturing process. In some embodiments the method may be used to monitor the operational state of a system forming at least part of an automotive manufacturing process. In such embodiments, the method may comprise measuring variable parameters of the automotive manufacturing process which may include screw torque and angle measurements, gauge position, angle measurements, voltage values registered by microprocessor, pointer positions, number of pixels on LCD, position of actuators and LCD brightness values, for example.

In some embodiments the method may additionally comprise isolating one or more components of a system in the event a fault has been identified in the operation of the system. In such embodiments, the method may comprise electrically or mechanically isolating the one or more components. In such embodiments, the method may comprise identifying which of the one or more variable parameters measured shows a discrepancy, and isolating only those components corresponding to the value of said measured variable parameter/s.

According to a second aspect there is provided a residual vector formation system for performing a method in accordance with the first aspect of the invention for monitoring the state of an operational system, the residual vector formation system comprising: a vector encoder for encoding an input vector from measurements of one or more variable parameters of the monitored operational system to form a feature vector; a prediction engine for generating a predicted vector characterising the predicted state of the operational system; and a residual vector generator for forming a residual vector from the generated feature and predicted vectors.

In some embodiments the residual vector formation system may comprise one or more sensors operable to measure one or more variable parameters of the operational system. In some embodiments the residual vector formation system may comprise two or more different types of sensor for measuring two or more different variable parameters of the operational system. In some embodiments the at least two of the two or more different sensor types may be operable to output values of different data types. For example, at least one sensor may comprise a binary sensor operable to output binary values for a given measured variable parameter (e.g. where the measured variable parameter can be in one of two states). In some embodiments at least one sensor may comprise a categorical sensor operable to output categorical values for a given measured variable parameter (e.g. where the variable parameter can be in one of two or more distinct states). In some embodiments at least one sensor may comprise a continuous sensor operable in use to output continuous values for a given variable parameter (e.g. where the measured variable parameter can take any value within a given range).

In some embodiments the at least one sensor may comprise a binary sensor which may be a pressure switch, temperature switch, thru-beam photoelectric sensor, proximity sensor or push button, for example. In some embodiments the at least one sensor may comprise a categorical sensor which may be a rotary switch having at least three angular positions, e.g. off, left, right, or a rotary switch which outputs the direction of rotation rather than an angular position, for example. In other embodiments the at least one sensor may comprise a continuous sensor which may be a thermistor, thermocouple, fibre optic pressure sensor, vacuum pressure sensor, elastic liquid based manometers, electromagnetic sensor, positional displacement sensor, thermal mass sensor, an accelerometer, motion sensor, ultrasound sensor, a semiconductor, infrared sensor, conductance sensor, or an electrochemical sensor, for example.

The vector encoder may be operable to encode an input vector from the measurements of the one or more variable parameters by generating an encoded vector wherein vector components of the encoded vector are represented as a binary number having a number of digits equal to a number of classes into which measured values of one or more variable parameters of the system may be classified. In such embodiments, the vector encoder may assign each digit of the binary number to a specific class.

The vector encoder may be operable to encode data from a binary sensor wherein the value of a measured variable parameter may be in one of two classes, i.e. in one of two separate states. In such embodiments, the vector encoder may be operable to generate a vector component which is assigned a value of “0” when the measured variable parameter is in one of the states and a value of “1” when in the other of the two states.

The vector encoder may be operable to encode data from a categorical sensor, wherein the value of a measured variable parameter may have one of two or more categorical values. In such embodiments, the vector encoder may be operable to generate one or more vector components for each category in which the variable parameter may be measured. The vector encoder may be operable to set the one or more components of the encoded vector to 0, and increase each component to 1 in the event that a measured value of the variable parameter falls within a corresponding category, in use.

The vector encoder may be operable to encode date from a continuous sensor, wherein the values which the variable parameter can take are continuous. In such embodiments, the vector encoder may be operable to assign one or more components of the encoded vector to one or more classes in the form of intervals within which the value of the measured variable parameter may fall. The vector encoder may be operable to set the one or more components of the encoded vector to 0, and increase each component to 1 in the event that a measured value of the variable parameter falls within a corresponding interval, in use. The vector encoder may be operable to determine the width of the intervals assigned to the one or more components of the encoded vector.

The vector encoder may be operable to repeat the digits of the generated binary number one or more times to form a repeated binary number. In some embodiments the vector encoder may be operable to repeat the digits of the generated binary number by repeating the whole of the generated binary number. For example, in such embodiments a generated binary number may read [0010] and a corresponding repeated binary number would read [00100010], where the generated binary number is repeated once. Alternatively, the vector encoder may be operable to repeat the digits of the binary number by repeating each of the digits of the generated binary number in turn. For example, in such embodiments a generated binary number may read [0010] and a corresponding repeated binary number would read [00001100], where the generated binary number is repeated once.

The residual vector formation system may additionally comprise a translation engine operable to translate the encoded vector into a different vector space. For example, in some embodiments the translation engine may be operable to translate the encoded vector into a feature space to form a feature vector. The translation engine may be operable to translate the encoded vector into a feature space through one or more non-linear transformations of the encoded vector. The feature vector may illustrate spatial and/or temporal transitional properties of the one or more measures variable parameters.

The prediction engine may be operable to statistically model one or more previously obtained feature vectors. In some embodiments the prediction engine may be operable to use a Markov chain to statistically model previously obtained feature vectors in order to generate a predicted vector. The Markov chain may be used to determine transition properties of the monitored system. The transition properties will preferably relate to temporal transitions (i.e. how the variable parameter/s change over time). The prediction engine may additionally be operable to use the Markov chain to model the probability of various temporal transitions occurring (i.e. being seen in a subsequent measured vector) on the basis of one of more previously obtained feature vectors. In this way, the prediction engine may be used to generate the predicted vector based on the most recent feature vector with reference to the probabilities of spatial or temporal transitions occurring before obtaining the next feature vector.

The prediction engine may be operable to store the spatial and temporal transition properties for future reference. The transition properties may be stored in a look-up table. The prediction engine may be operable to continually update the look up table each time a feature vector is obtained.

In some embodiments the prediction engine may be operable to assign a feature vector to an individual operational system state. The prediction engine may be operable to cluster feature vectors which are deemed to correlate in some way but which are not necessarily identical into a single operational system state.

In some embodiments the prediction engine is operable to cluster feature vectors which are separated by a pre-determined distance in feature space. The distance between two or more feature vectors may be calculated from the Euclidian distance between them in feature space. The prediction engine may be operable to represent clustered vectors as a clustered vector in the same feature space. The cluster vector may be taken to be the midpoint between the two or more feature vectors. The prediction engine may be operable to perform clustering of all feature vectors which are within a given distance from each other in feature space.

In further embodiments the prediction engine is operable to repeat the clustering process discussed above one or more times. For each subsequent run of the clustering process the prediction engine may increase the threshold distance below which two vectors are deemed to correlate. In some embodiments the prediction engine is operable in use such that for the second and subsequent runs of the clustering process, the prediction engine may cluster two or more feature vectors together, one or more feature vectors with one or more generated cluster vectors, or two or more cluster vectors, for example. The prediction engine may be operable to repeat the clustering process any number of times up until a single cluster vector is generated representing an overview of the system state. In this way, the prediction engine may be operable to form a hierarchical model of system states with each run of the clustering process corresponding to a tier of the hierarchy.

The residual vector generator is operable to form a residual vector from a generated feature vector and a predicted vector. In some embodiments the residual vector generator may be operable to subtract the feature vector from the predicted vector. In some embodiments the residual vector generator may be operable to subtract the value of each component of the feature vector from the value of the corresponding component in the predicted vector.

In some embodiments the residual vector generation system may additionally comprise an output device. The output device may comprise a visual and/or audio output device for communicating information to a user. For example, the output device may comprise an alarm, one or more LEDs or other lighting devices, or a visual display unit (VDU). The output device may be operable to output information relating to the state of the operational system being monitored. In some embodiments the output device may be operable to output information to a user when a fault is detected in the monitored operational system, in use.

According to a third aspect of the present invention there is provided a method of encoding vector components for use in a method for monitoring the operational state of a system in accordance with the first aspect of the invention, the method comprising the steps of:
(a) generating each vector component as a binary number having a number of digits equal to a number of categories into which measured values of one or more variable parameters of the system may be classified, each digit of the binary number corresponding to a specific category; and
(b) repeating the generated binary number n times to form an encoded vector from the vector components.

The third aspect of the invention may include any or all of the features of the methods in accordance with the first aspect of the invention as is desired or is appropriate.

The generated binary number is repeated one or more times to form an encoded vector from the vector components in the form of a repeated binary number. The repeated binary number may be generated for stability during subsequent processing of the formed measured vector. In some embodiments the digits of the generated binary number may be repeated by repeating the whole of the generated binary number. For example, in such embodiments a generated binary number may read [0010] and a corresponding repeated binary number would read [00100010], where the whole generated binary number, that is all four vector components of the generated binary number, is repeated once. Alternatively, the digits of the binary number may be repeated by repeating each of the digits of the generated binary number in turn. For example, in such embodiments a generated binary number may read [0010] and a corresponding repeated binary number would read [00001100], where the generated binary number is repeated once.

In some embodiments the method may comprise measuring at least one value of a variable parameter which may be in one of two categories, i.e. in one of two separate states. In such embodiments, the method may comprise generating each vector component as a binary number having a single digit. The single digit may be assigned a value of “0” if the measured parameter is in a first state, with a value of “1” being assigned to the other of the two states.

In some embodiments the method may comprise measuring at least one value of a variable parameter which may fall into one of two or more categories, i.e. where the measured variable parameter may have one of two or more categorical values. In such embodiments, the method may comprise generating each vector component as a binary number having a number of digits corresponding to the number of categories into which the value of the variable parameter may fall. The two or more digits of the generated binary number may be set to 0, and may be increased to 1 in the event that a measured value of the variable parameter falls within a corresponding category.

In some embodiments the method may comprise measuring at least one value of a variable parameter wherein the values which the variable parameter can take are continuous. In such embodiments, the method may comprise generating each vector component as a binary number having a number of digits corresponding to a number of intervals into which the measured variable parameter may fall. The one or more digits of the generated binary number may be set to have a real-number variable of 0, and may be increased to 1 in the event that a measured value of the variable parameter falls within a corresponding interval.

In some embodiments the method may comprise forming a normal distribution using two or more measured values of a variable parameter. In such embodiments, the normal distribution may be used to calculate the mean value (μ) of the variable parameter and also the standard deviation (σ) from this mean value. The method may comprise generating a binary number having a number of digits corresponding to a set number of intervals between two distinct multiples of standard deviation from the mean of the normal distribution of data points. For example, the interval width may be defined as 0.25 σ. In such embodiments, the generated binary number may comprise a number of digits, each digit corresponding to an interval defined by multiples of standard deviation from a calculate mean. For example, a first digit of the binary number may be assigned to values falling between 0 σ and 0.25 σ, a second digit of the binary number may be assigned to values falling between 0.25 σ and 0.5 σ, a third digit of the binary number may be assigned to values falling between 0.5 σ and 0.75 σ, and so on up to one or more “nth” digits of the generated binary number. In the event that a measured value of a given variable parameter falls within a given interval, the corresponding digit of the generated binary number assigned to that interval may have its value set at 1, whereas each of the other digits of the binary number will be set at 0. In this way, the method comprises a means to encode continuous data in a binary vector.

### DETAILED DESCRIPTION OF THE INVENTION

In order that the invention may be more clearly understood an embodiment thereof will now be described, by way of example only, with reference to the accompanying drawings, of which:

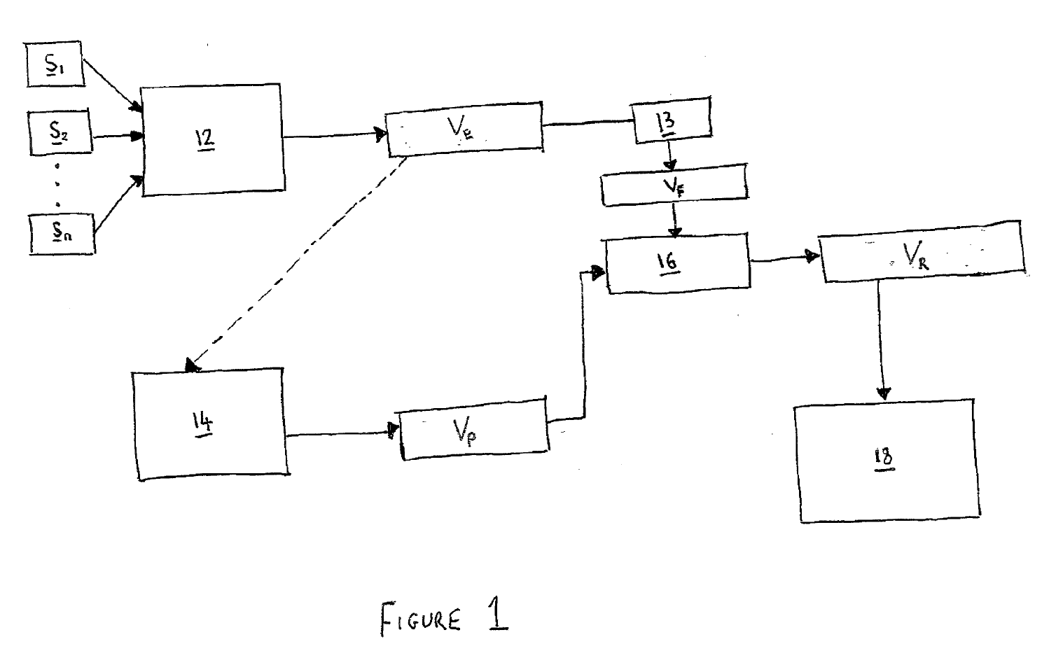

FIG. 1 is a flow diagram illustrating embodiments of a method in accordance with the invention;

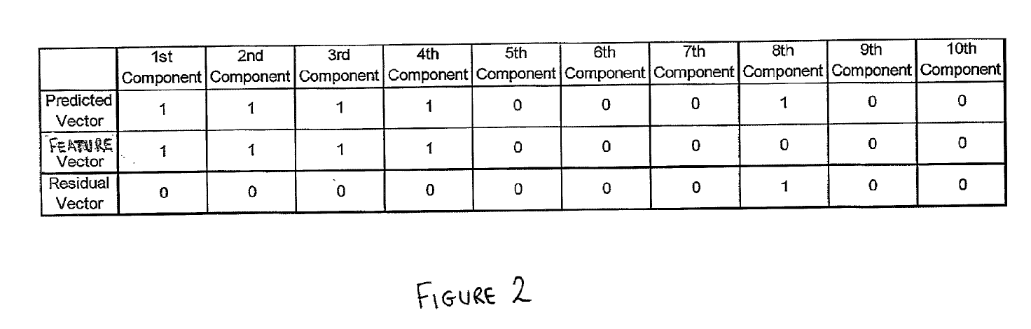

FIG. 2 is a table illustrating the generation of a residual vector in accordance with embodiments of the invention;

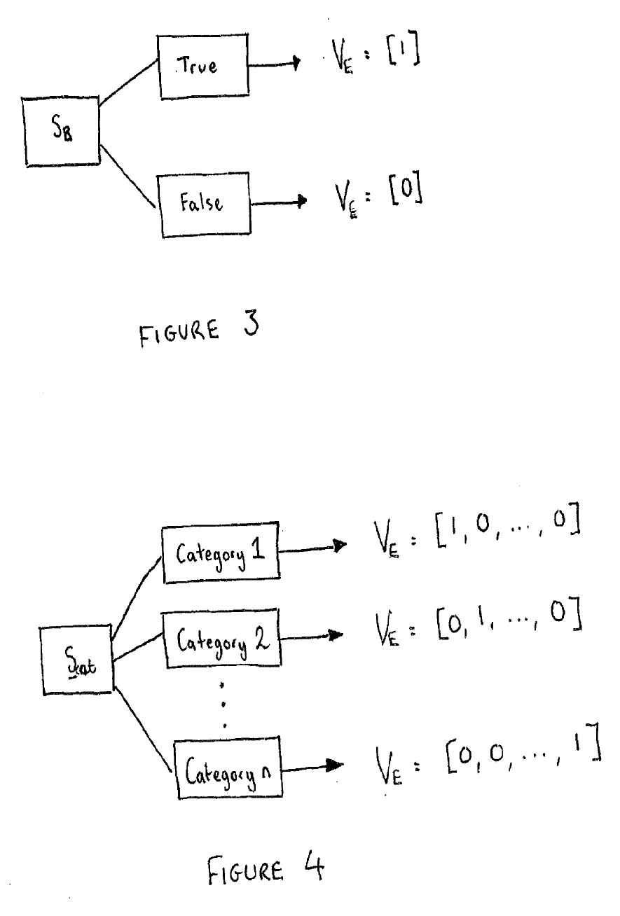

FIG. 3 is a graphical representation of an embodiments of an encoding process forming part of a method in accordance with embodiments of the invention;

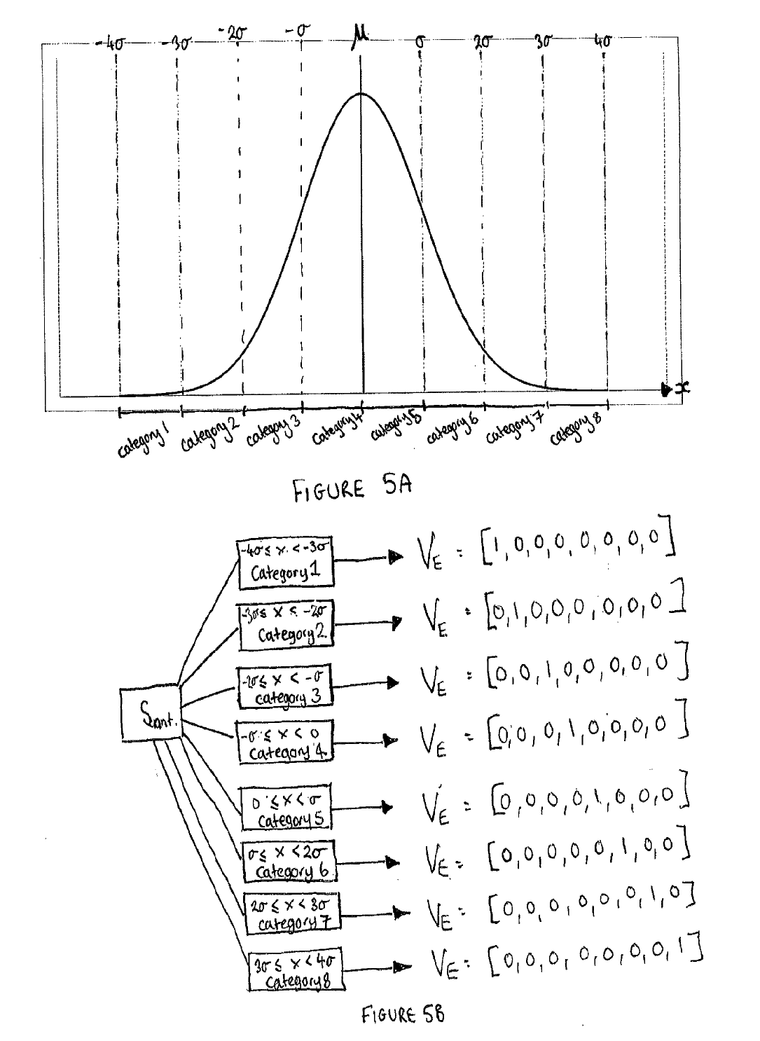

FIG. 4 is a graphical representation of a further embodiment of an encoding process forming part of a method in accordance with embodiments of the invention; and

FIGS. 5A and 5B are a graphical representation of a further embodiment of an encoding process forming part of a method in accordance with embodiments of the invention.

A method in accordance with the present invention is now described with reference to FIG. 1, which is a flow diagram illustrating embodiments of the present invention.

Signals are obtained from a plurality of sensors S₁, S₂, Sₙ and fed into an encoder 12. The encoder 12 is operable in use to receive input signals from each of the sensors S₁, S₂, Sₙ and translate said signals into one or more vectors characterising the state of one or more of the operational parameters of the monitored system, hereinafter referred to as an encoded vector V_{E}.

The signals from the sensors S₁, S₂, Sₙ may relate to one or more different operational parameters of a connected system and may provide data to the encoder 12 in one or more different forms. For example, one or more of the sensors S₁, S₂, Sₙ may comprise binary sensors which output a binary code to the encoder 12, or may comprise categorical sensors which output a signal relating to which of one or more categories the measured parameters falls within. In some embodiments one or more of the sensors S₁, S₂, Sₙ may be a sensor operable to output data relating to a continuous parameter. The operation of the different sensor types are illustrated in FIGS. 3, 4, 5A and 5B and are discussed in detail below.

The encoded vector V_{E} is fed into a translation engine 13 which translates the encoded vector V_{E} into feature space to form a feature vector V_{F}. The feature vector V_{F} is subsequently fed into a residual vector generator 16 which compares the feature vector V_{F} with a predicted vector Vₚ generated by a prediction engine 14. The predicted vector Vₚ preferably characterises any expected spatial and/or temporal variations in the values of the one or more parameters of the monitored system measured by sensors S₁, S₂, Sₙ.

The residual vector generator 16 is operable to compare the feature vector V_{F} with a predicted vector Vₚ and output a residual vector V_{R} which characterises any differences between the feature vector V_{F} and the predicted vector Vₚ, i.e. characterises any differences between the expected variations in the values of the parameters of the monitored system and the actual observed variations in measured values taken from the data obtained by the sensors. The operation of the residual vector generator 16 in generating the residual vector V_{R} is illustrated in FIG. 2 and is discussed in detail below.

In addition, the feature vector V_{F} is also fed directly into the prediction engine 14. In this way, the current operational state of each of the variable parameters of the monitored system can be input into the prediction engine 14 to update subsequent predictions made by the prediction engine 14. This is performed using statistical modelling of one or more feature vectors, which may include a number of previously obtained feature vectors along with the latest feature vector V_{F} generated by the translation engine 13. The statistical modelling of the feature vectors V_{F} to form the predicted vector Vₚ by the prediction engine 14 is described in detail below.

The formed residual vector V_{R} is then input into a computation unit 18 for analysis. Typically, this analysis may involve determining whether the differences identified between the predicted and feature vectors Vₚ, V_{F} indicate that there is a fault in the monitored system.

The method of the invention may be used (but is not limited to use) in the following applications:

The vehicle instrument clusters production line requires the assembly of a number of components and their testing to ensure correct functionality and product conformity meeting client needs. This process is highly complex and distributed, involving over 600 different operations, for example screw torque and angle measurements, electrical voltage tests, LCD brightness functional quality checks, CAN/LIN interface tests, gauge position angle measurements and many other functional and visual tests. Data pertaining to these production tests is collected from various workstations at different assembly points over a specific production line. The proposed approach is used for automatically learning the correlations and causative relationships between variables both in time and space, to be used to identify patterns in data to infer potential process abnormalities and fault occurrences. This is based on based on data pertaining to measured vectors and predictions of normal process operations from which a residual vector indicating a specific fault (based on the measured sensor parameters) can be detected. This information may be used to determine machine reliability (wear and tear, sensory or actuation failures) and suggest corrective actions and tolerances for adapting and configuring production machines based on conformity constrains, for example.

Fault Detection and predictive maintenance for transport fleet management based on categorical, real valued and binary data collected from vehicle maintenance records, Engine management system and CAN-Bus data on vehicle and driver interaction parameters, route, operational load previous faults. This data could be used to build models for modelling spatial/temporal cause—effect relationships predictive maintenance which could be used to determine what selected equipment/parts need to be maintained to avoid loss of revenue. The detection of these faults can be based on data pertaining to measured vectors and predictions of normal fleet operational conditions from which a residual vector indicating a specific behaviour change (based on the measured parameters) can be detected to indicate the occurrence of a specific type of fault, for example.

Detection of behaviour abnormalities in daily living activities of people suffering from dementia wherein a plethora of environmental sensors and actuators sensing aspects of user activities and behaviour in the environment and user actuations of various computational artefacts can be captured. The approach can be used to discover complex spatial and temporal correlations, which can be used to determine the occurrence of different categories of behaviour abnormalities, which can be a sign of cognitive impairments. The detection of these abnormalities can be based on monitored data pertaining to measured vectors and predictions of normal behaviours and activities from which a residual vector indicating a specific behaviour changes (based on the measured parameters) can be detected. This can be used to determine appropriate care intervention, for example.

FIG. 2 is a table illustrating how the residual vector V_{R} may in some embodiments be generated by the residual vector generator 16 from the generated feature vector V_{F} and the predicted vector Vₚ. In the illustrated method, the residual vector V_{R} is generated by subtracting the feature vector V_{F} from the predicted vector Vₚ. This is done by subtracting each separate component of the feature vector V_{F} from the corresponding component in the predicted vector Vₚ as shown in FIG. 2. As will be described below, each component of the vectors may relate to the value of one or more variable parameters of the monitored system. In this way, where the residual vector V_{R} shows a difference between the measured and predicted values for a given component (see the 8^{th} component in the illustrated embodiment) this can be used to directly identify which variable parameter of the monitored system has a measured value which is different to or has changed spatially or temporally by a greater or lesser amount to what was expected.

FIGS. 3, 4, 5A and 5B illustrate embodiments of methods for encoding an encoded vector V_{E}. It should, however, be understood that the present invention is not limited to these methods but rather is intended to include any method for encoding an encoded vector V_{E} for use in monitoring the operational state of a system as per the method of the invention.

FIG. 3 illustrates how a sensor S_{B} may be used to measure at least one value of a variable parameter which may be in one of two classes, i.e. in one of two separate states. In the illustrated embodiment, the sensor S_{B} comprises a binary sensor which may output one of two values, which in this case is shown to be “True” or “False” (relating to off or on/open or closed, etc. of a monitored parameter). As shown, in order to translate the measured values from the binary sensor S_{B} to real-number variables for inclusion in the encoded vector V_{E}, the method comprises simply assigning a binary value, i.e. 0 or 1, to a corresponding component within the encoded vector V_{E}. In the illustrated method, this comprises assigning the binary value of 1 to a “True” output and the binary value 0 to a “False” output. The formed encoded vector V_{E} comprises only a single component which takes the binary value of the corresponding output. However, in some variations the components of the encoded vector V_{E} may be repeated n times. For example, a repeated encoded vector V_{E} may read either [1, 1, 1, 1, . . . , 1] or [0, 0, 0, 0, . . . , 0], where the components are repeated n times.

FIG. 4 illustrates how a sensor S_{Cat} may be used to measure at least one value of a variable parameter which may fall into one of two or more classes, i.e. where the measured variable parameter may have one of two or more categorical values. In the illustrated embodiment, the sensor S_{Cat} may comprise a categorical sensor operable to output one or two or more values corresponding to two or more categories into which the measured value of the variable parameter falls. Variable parameters having two or more categorical values may include colours, or operational settings having two or more discrete values, for example. As shown, in order to translate the measured values from the categorical sensor S_{Cat} to real-number variables for inclusion in the encoded vector V_{E}, the method comprises assigning each category to a corresponding component within the encoded vector V_{E}. Where a variable parameter is measured to fall within a given category, this is output from the sensor S_{Cat} and a binary value of 1 is assigned to the corresponding component of the encoded vector V_{E}, as shown. The formed encoded vector V_{E} comprises a number of components equal to the number of categories into which the measured parameter of the system may fall. However, in some variations the components of the encoded vector V_{E} may be repeated n times. For example, a formed encoded vector V_{E} may read [0, 1, 0, 0, . . . , 0] where the measured parameters falls within the second category and the corresponding repeated encoded vector would read [0, 1, 0, 0, . . . , 0, 0, 1, 0, 0, . . . , 0] where the whole formed encoded vector V_{E} is repeated twice. Alternatively, a formed encoded vector V_{E} may read [0, 1, 0, 0, . . . , 0] where the measured parameter falls within the second category and the corresponding repeated encoded vector would read [0, 0, 1, 1, 0, 0, 0, 0, . . . , . . . , 0, 0] where each component of the formed encoded V_{E} vector is repeated in turn.

FIGS. 5A and 5B illustrate how a sensor S_{Cont} may be used to measure at least one value of a variable parameter wherein the values which the variable parameter can take are continuous. In the illustrated embodiment, the method comprises assigning components of the encoded vector V_{E} to one or more classes in the form of intervals within which the value of the measured variable parameter may fall. This is shown graphically in FIG. 5B where the components of the encoded vector V_{E} are each set to have a real-number variable of 0, which is increased to 1 in the event that a measured value of the variable parameter falls within a corresponding interval.

FIG. 5A illustrates how the intervals are generated from a normal distribution of previously measured values of the variable parameter. The normal distribution is then used to calculate the mean value μ of the variable parameter and also the standard deviation σ from this mean value μ, including multiples of standard deviation therefrom. Each component of the encoded vector V_{E} is assigned to a class defined by an interval between two distinct multiples of standard deviation σ from the mean μ of the normal distribution of data points. In the illustrated embodiment the interval width is equal to the standard deviation σ. Therefore, the first component of the encoded vector V_{E} is assigned to values falling in the range −4 σ to −3 σ, the second component of the encoded vector V_{E} is assigned to values falling between −3 σ and −2 σ, and so on up to the eight component of the encoded vector V_{E} assigned to values falling between 3 σ and 4 σ. In the event that a measured value of a given variable parameter falls within a given interval, the corresponding vector component assigned to that interval has its value set at 1, whereas each of the other components relating to the further intervals have their value set at 0. In this way, the method comprises a means to encode continuous data in a binary vector.

Again, in some variations the components of the encoded vector V_{E} may be repeated n times. For example, a formed encoded vector V_{E} may read [0, 1, 0, 0, 0, 0, 0, 0] where the measured parameter falls within the second category, corresponding to the interval between −3 σ and −2 σ and the corresponding repeated encoded vector would read [0, 1, 0, 0, 0, 0, 0, 0, 0, 1, 0, 0, 0, 0, 0, 0] where the whole formed encoded vector is repeated twice. Alternatively, a formed encoded vector V_{E} may read [0, 1, 0, 0, 0, 0, 0, 0] where the measured parameter falls within the second category, corresponding to the interval between −3 σ and −2 σ and the corresponding repeated encoded vector would read [0, 0, 1, 1, 0, 0, 0, 0, 0, 0, 0, 0, 0, 0, 0, 0] where each component of the formed encoded vector is repeated in turn.

The prediction engine 14 preferably uses a Markov chain to statistically model previously generated feature vectors V_{F} in order to generate a predicted vector Vₚ. The Markov chain is used to determine transition properties of the monitored system by forming a look up table of possible states of that system and statistically analysing the frequency of different states measured to determine said transition properties. The transition properties relate to spatial transitions (i.e. how the variable parameter/s change in parameter space) and to temporal transitions (i.e. how the variable parameter/s change over time). To generate the predicted vector, Vₚ, the prediction engine 14 predicts the next state of a system by looking at the probability of various spatial or temporal transitions occurring (i.e. being seen in a subsequent measured vector) on the basis of the current state of the system (characterised by the most recently obtained feature vector V_{F}). For example, in the event that the statistical model suggests that the probability of there being any alternative variation in one or more of the parameters to what is shown in the previously obtained feature vector V_{F} is low (which may be below a specified threshold value) the predicted vector Vₚ may be equal to the last feature vector V_{F}. Alternatively, in the event that the statistical model suggests that the probability of there being any alternative variation in one or more of the parameters to what is shown in the previously obtained feature vector V_{F} is high (which may be above a specified threshold value) the predicted vector Vₚ may differ from the last feature vector V_{F} in relation to the variables which are deemed to have a high probability of varying to a greater or lesser extent to that illustrated by the feature vector V_{F}, for example. The prediction engine 14 is operable to store the spatial and temporal transition properties are for future reference in the look-up table and in this way, the look-up table is continually updated each time a feature vector V_{F} is obtained to continually update the prediction process to better predict the next state of the monitored system.

The above embodiment is described by way of example only. Many variations are possible without departing from the scope of the invention as defined in the appended claims.

1. A method for monitoring the operational state of a system having one or more variable parameters comprising the steps of:
(a) forming an input vector containing one or more values for the or each variable parameter of the monitored system;
(b) encoding the input vector to form an encoded vector;
(c) translating the encoded vector into feature space to form a feature vector;
(d) generating a predicted vector containing a corresponding number of predicted values for the values of the formed feature vector, wherein the predicted values are generated by using a Markov chain to statistically model the probability of various spatial or temporal transitions occurring on the basis of one or more previously generated feature vectors;
(e) subtracting the feature vector from a predicted vector to form a residual vector; and
(f) using the residual vector to identify one or more discrepancies in spatial and/or temporal changes in the or each variable parameter of the monitored system, so as to thereby identify a fault in the operation of the monitored system.

2. A method as claimed in claim 1 wherein subtracting the feature vector from the predicted vector comprises subtracting the or each real-number variable within the feature vector from a corresponding value in the predicted vector and wherein the corresponding value in the predicted vector is the equivalent vector component of the feature vector.

3. (canceled)

4. (canceled)

5. A method as claimed in claim 2 wherein each time a feature vector is generated, the feature vector is additionally incorporated into a statistical model for generating a further predicted vector for use in analysis of a subsequently formed feature vector.

6. (canceled)

7. (canceled)

8. (canceled)

9. A method as claimed in claim 1 comprising assigning each feature vector to an individual system state.

10. A method as claimed in claim 9 wherein feature vectors deemed to correlate are clustered together into a single system state.

11. A method as claimed in claim 10 comprising clustering feature vectors which are separated by a pre-determined distance in feature space and wherein clustering of two or more feature vectors is expressed by a clustered vector in the same feature space.

12. (canceled)

13. (canceled)

14. A method as claimed in claim 11 wherein the clustering process is repeated one or more times, the method comprising, for the second and subsequent runs of the clustering process, clustering: two or more feature vectors together; one or more feature vectors with one or more generated cluster vectors; or two or more cluster vectors.

15. A method as claimed in claim 1 wherein the at least one value of the or each variable parameter is acquired by monitoring equipment comprising one or more sensors.

16. (canceled)

17. A method as claimed in claim 1 comprising generating each vector component of the encoded vector as a binary number having a number of digits equal to a number of classes into which measured values of one or more variable parameters of the system may be classified, each digit of the binary number corresponding to a specific class; and wherein the generated binary number is repeated one or more times to form a repeated binary number.

18. (canceled)

19. (canceled)

20. A method as claimed in claim 17 wherein the repeated binary number is formed by repeating the whole of the generated binary number, or by repeating each of the digits of the generated binary number in turn.

21. A method as claimed in claim 1 used to monitor the operational state of a system to detect a fault within the system, wherein any discrepancies in identified spatial and temporal changes in the measured value or values of the or each variable parameter are taken to be an indication of a fault within the monitored system.

22. A method as claimed in claim 21 wherein a fault is identified when at least one component of the feature vector differs from a corresponding vector component of the predicted vector such that one or more of the components of the residual vector are not equal to zero, or when two or more components of the feature vector differ from a corresponding vector component of the predicted vector such that two or more of the components of the residual vector are not equal to zero, or when the magnitude of the residual vector exceeds a predetermined threshold value.

23. A method as claimed in claim 21 comprising isolating one or more components of a system in the event a fault has been identified in the operation of the system.

24. (canceled)

25. A residual vector formation system for performing for monitoring the state of an operational system, the residual vector formation system comprising: a vector encoder for encoding an input vector from measurements of one or more variable parameters of the operational system to form a feature vector; a prediction engine for generating a predicted vector characterising the predicted state of the operational system wherein the predicted vector is generated by using a Markov chain to statistically model the probability of various spatial or temporal transitions occurring on the basis of one or more previously generated feature vectors; and a residual vector generator for forming a residual vector from the generated feature and predicted vectors, so as to thereby identify a fault in the operation of the monitored system.

26. A system as claimed in claim 25 wherein the vector encoder is operable to encode an input vector from the measurements of the one or more variable parameters by generating an encoded vector wherein vector components of the encoded vector are represented as a binary number having a number of digits equal to a number of classes into which measured values of one or more variable parameters of the system may be classified; and wherein the vector encoder is operable to repeat the digits of the generated binary number one or more times to form a repeated binary number.

27. (canceled)

28. (canceled)

29. A system as claimed in claim 25 comprising one or more sensors operable to measure the one or more variable parameters of the operational system.

30. (canceled)

31. (canceled)

32. (canceled)

33. (canceled)

34. A system as claimed in claim 25 comprising an output device comprising a visual and/or audio output device for communicating information to a user.

35. (canceled)

36. (canceled)

37. (canceled)

38. (canceled)

39. A method as claimed in claim 17 comprising measuring at least one value of a variable parameter which may be in one of two categories and generating each vector component as a binary number having a single digit, the single digit being assigned a value of 0 is the measured parameter is in a first state, and a value of 1 if measured in the other of the two states.

40. A method as claimed in claim 17 comprising measuring at least one value of a variable parameter which may fall into one of two or more categories, and generating each vector component as a binary number having a number of digits corresponding to the number of categories into which the value of the variable parameter may fall.

41. A method as claimed in claim 17 comprising measuring at least one value of a variable parameter wherein the values which the variable parameter can take are continuous, and generating each vector component as a binary number having a number of digits corresponding to a number of intervals into which the measured variable parameter may fall.

42. (canceled)
